(19) United States
(12) Patent Application Publication
(10) Pub. No.: US 2009/0007986 A1
(43) Pub. Date: Jan. 8, 2009

(54) PNEUMATIC TOOL WITH DUST-BLOWING EFFECT

(76) Inventor: Freddy LIN, Wu-Jih Hsiang (TW)

Correspondence Address: SINORICA, LLC, 528 FALLSGROVE DRIVE, ROCKVILLE, MD, 20850, US

(21) Appl. No.: 11/774,001

(22) Filed: Jul. 6, 2007

(51) Int. Cl. B27C 5/10

(52) U.S. Cl. 144/252.1

(57) ABSTRACT

A pneumatic tool includes a housing formed with an internal blowing flow way and an intake flow way. A blowing nozzle is disposed on a certain section of the housing and connected with a front end of the blowing flow way. A pneumatic cylinder is installed in a cylinder room of the housing. A switch is arranged between the intake flow way and the cylinder room and switchable between an intake position and a blowing position. High-pressure air flows from the intake flow way to the switch. An air conduit is formed on a front end of the switch. A shift button is mounted on the housing and connected with the switch. In use, when the switch is switched to the intake position, the air conduit of the switch communicates with the intake of the cylinder for driving the cylinder. When the switch is switched to the blowing position, the air conduit communicates with the rear end of the blowing flow way, whereby the high-pressure air blows out from the blowing nozzle to blow away dusts and chips. Accordingly, the pneumatic tool is able to blow dust and chips away.

### BACKGROUND OF THE INVENTION

The present invention is related to a pneumatic tool, and more particularly to a pneumatic tool with dust-blowing effect, which is able to effectively remove the processing chips accumulating on a processed surface of a work piece.

When using a pneumatic tool to grind or mill a work piece, the processing chips often accumulate on a processed surface of the work piece. In some cases, the chips are mixed with lubricant or water. Therefore, there is often a mass on the processed surface. An operator needs to frequently clean up the processing chips and dirt for clearly seeing the processed surface and realizing the processing progress.

The conventional pneumatic tool is not equipped with any unit for removing the processing chips. Therefore, it is troublesome for an operator to frequently clean up the dirt from the processed surface.

### SUMMARY OF THE INVENTION

It is therefore a primary object of the present invention to provide a pneumatic tool with dust-blowing effect, which is able to effectively remove the processing chips accumulating on a processed surface of a work piece.

According to the above object, the pneumatic tool with dust-blowing effect of the present invention is equipped with a switch for switching the flowing directions of high-pressure air. When high-pressure air is guided into a blowing flow way, the high-pressure air can blow out from a blowing nozzle of the housing of the pneumatic tool to blow away the processing chips.

The present invention can be best understood through the following description and accompanying drawings wherein:

### BRIEF DESCRIPTION OF THE DRAWINGS

FIG. 1 is a side view of an embodiment of the present invention;

FIG. 2 is a longitudinally sectional view of the embodiment of the present invention according to FIG. 1;

FIG. 3 is a sectional view taken along line 3-3 of FIG. 1;

FIG. 4 is a rear perspective view of the pneumatic cylinder of the embodiment of the present invention;

FIG. 5 is a rear perspective view of the pneumatic cylinder and the switch of the embodiment of the present invention;

FIG. 6 is a perspective exploded view according to FIG. 5;

FIGS. 7 and 8 are perspective exploded views of the components of FIG. 6;

FIG. 9 is a rear end view according to FIG. 5;

FIG. 10 is a sectional view taken along line 10-10 of FIG. 9;

FIG. 11 is a sectional view taken along line 11-11 of FIG. 10;

FIG. 12 is a perspective exploded view of the flow-guiding seat of a preferred embodiment of the present invention;

FIG. 13 is a sectional view taken along line 13-13 of FIG. 10;

FIG. 14 is a sectional view taken along line 14-14 of FIG. 10;

FIG. 15 is a sectional view taken along line 15-15 of FIG. 10, showing that the switch is positioned in the blowing position;

FIG. 16 is a sectional view taken along line 16-16 of FIG. 1;

FIG. 17 is a view according to FIG. 15, showing that the switch is positioned in the intake position;

FIG. 18 is a sectional view of another embodiment of the present invention;

FIG. 19 is a side view of the pneumatic cylinder and the switch of the embodiment of FIG. 18;

FIG. 20 is a sectional view taken along line 20-20 of FIG. 19;

FIG. 21 is a rear end view of the switch and the pneumatic cylinder of another embodiment of the present invention;

FIG. 22 is a sectional view taken along line 22-22 of FIG. 21;

FIG. 23 is a rear end view of the switch and the pneumatic cylinder of still another embodiment of the present invention; and

FIG. 24 is a sectional view taken along line 24-24 of FIG. 23.

### DETAILED DESCRIPTION OF THE PREFERRED EMBODIMENTS

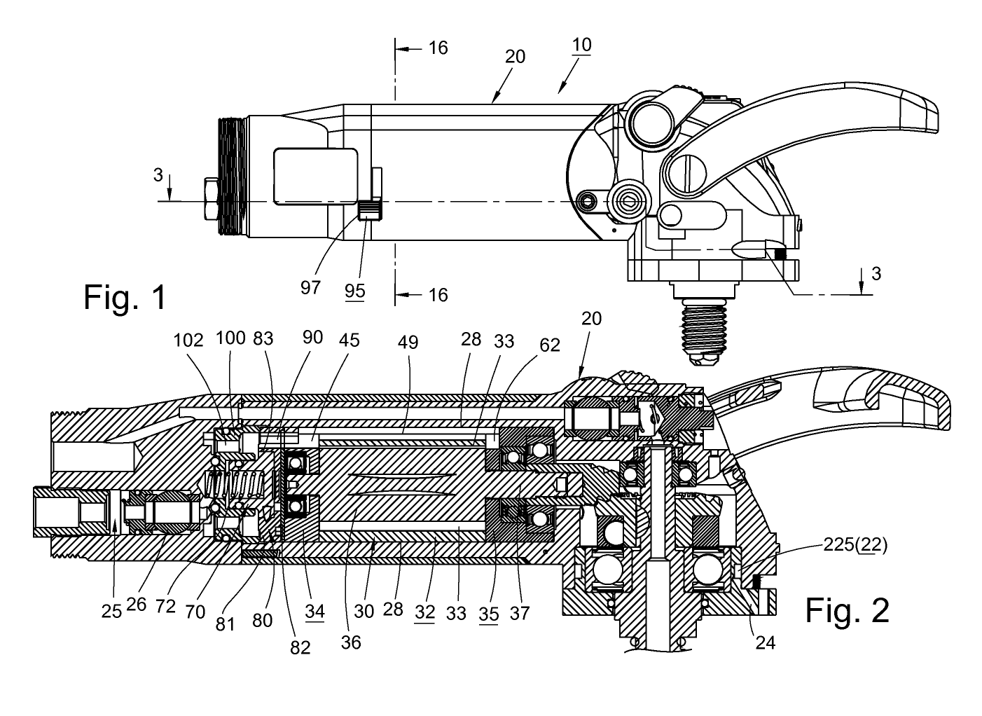

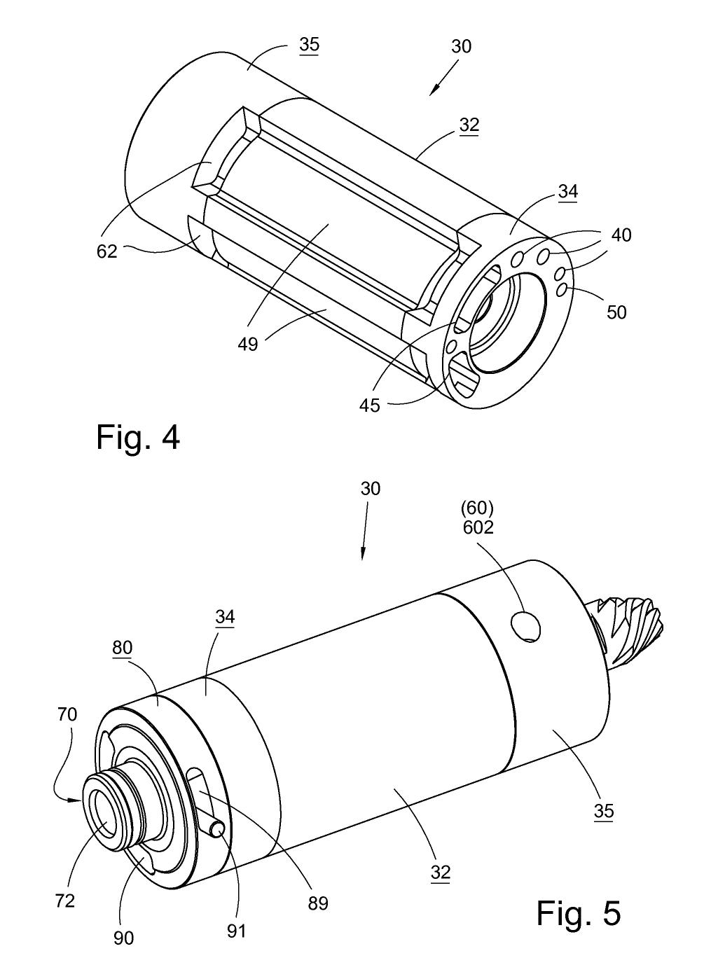

FIGS. 1 and 2 show a first embodiment of the pneumatic tool 10 of the present invention. It should be noted that in the embodiment there are many elements of the same kind that are shown plurally in the drawings. For example, In FIG. 4, there are three intakes 40 and two exhaustion ports 45. However, such elements are described singularly in the specification and the claim. In practice, the pneumatic tool of the present invention can equivalently include only one single such element.

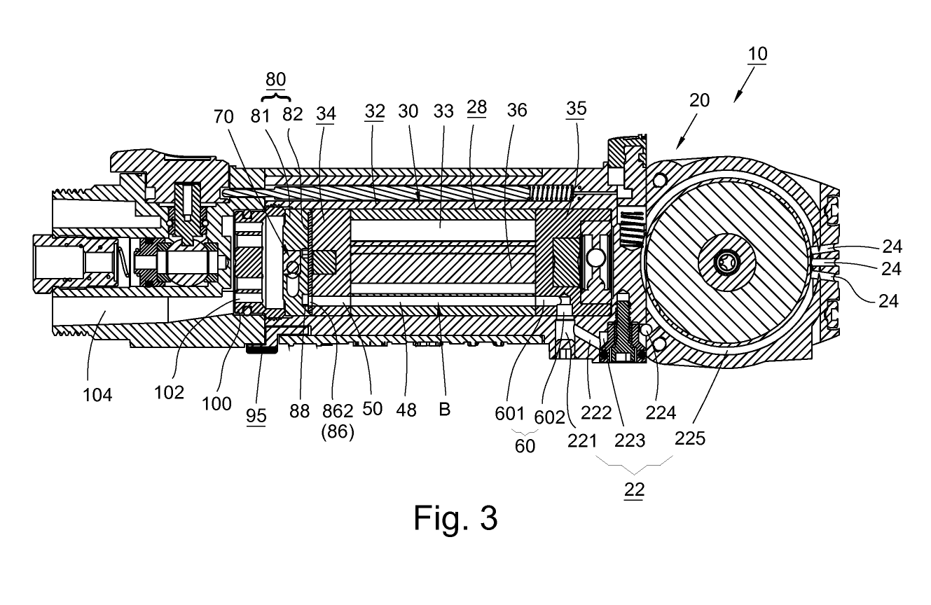

Referring to FIG. 3, the pneumatic tool 10 has a housing 20 formed with a blowing flow way 22. A front end of the blowing flow way 22 is connected with a blowing nozzle 24 formed at a front end of the housing 20. The air can be blown out from the blowing nozzle to remove the grinding powders.

Referring to FIG. 2, a rear section of the housing 20 is formed with an intake flow way 25 through which high-pressure air can go into the pneumatic tool 10. A valve 26 is disposed in the flow way 25 for controlling opening/closing thereof. A cylinder room 28 is formed in the housing 20. A rear end of the cylinder room 28 communicates with the front end of the intake flow way 25. The rear end of the blowing flow way 22 communicates with the cylinder room 28.

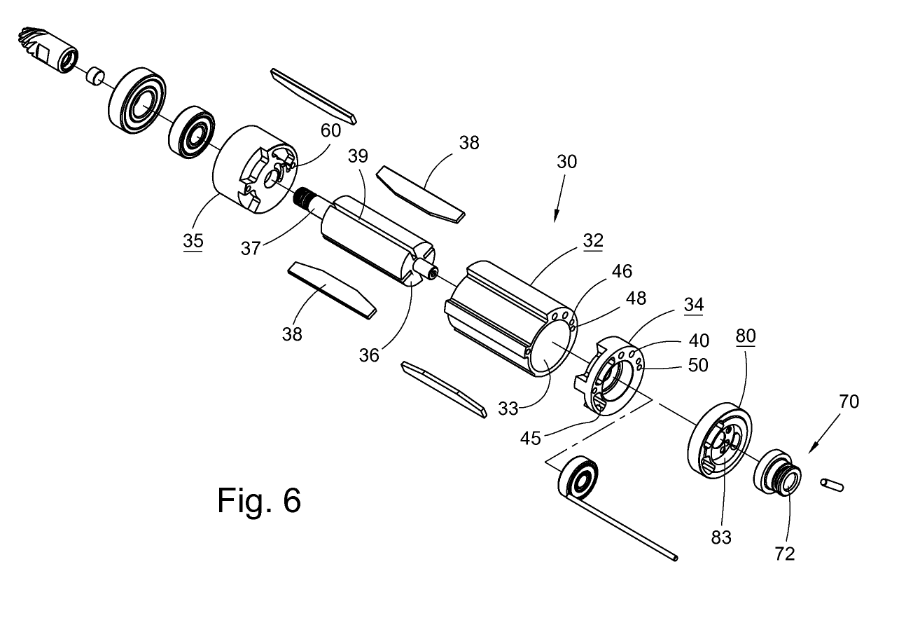

A pneumatic cylinder 30 is disposed in the cylinder room 28. Referring to FIG. 4, the pneumatic cylinder 30 has a cylinder body 32 and two cylinder caps 34, 35 mounted at two ends of the cylinder body 32. The pneumatic cylinder 30 is formed with an intake 40 and an exhaustion port 45. Accordingly, the high-pressure air can flow from the intake 40 into the pneumatic cylinder 30 and be exhausted from the exhaustion port 45. Referring to FIG. 6, a rotor 36 is installed in an operation space 33 of the pneumatic cylinder 30. Two ends of a rotary shaft 37 of the rotor 36 are rotatably fitted in the cylinder caps 34, 35, whereby the rotor can rotate. Several vanes 38 are inlaid in several vane splits 39 formed on the circumference of the rotor 36.

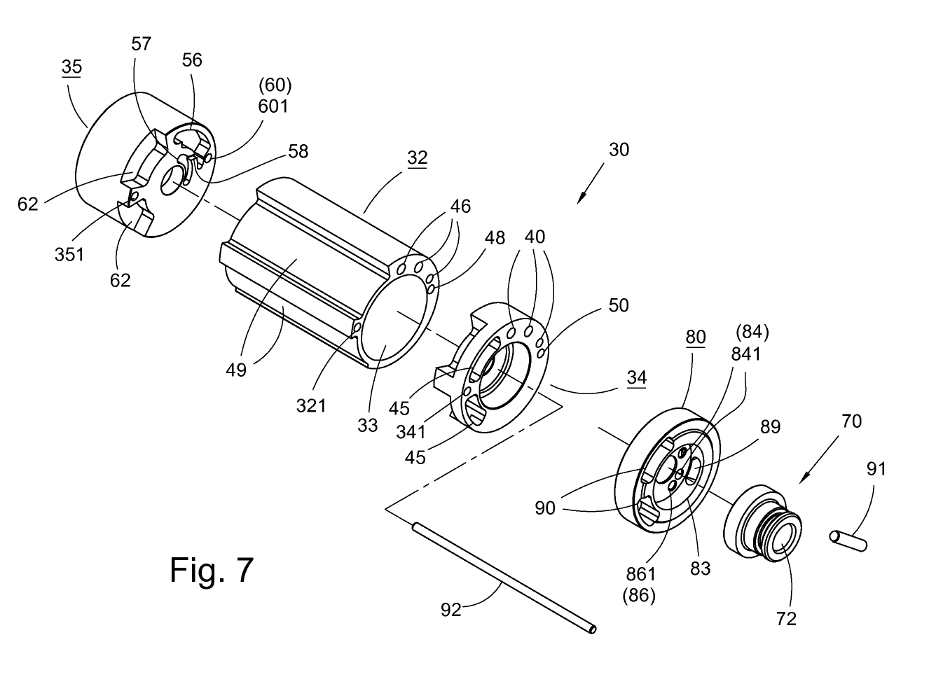

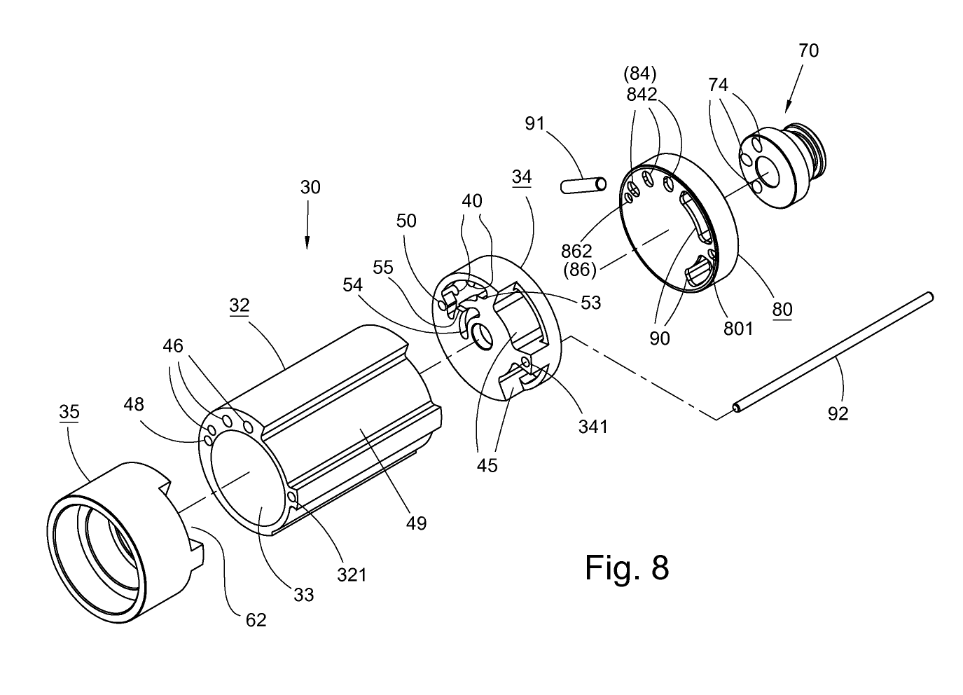

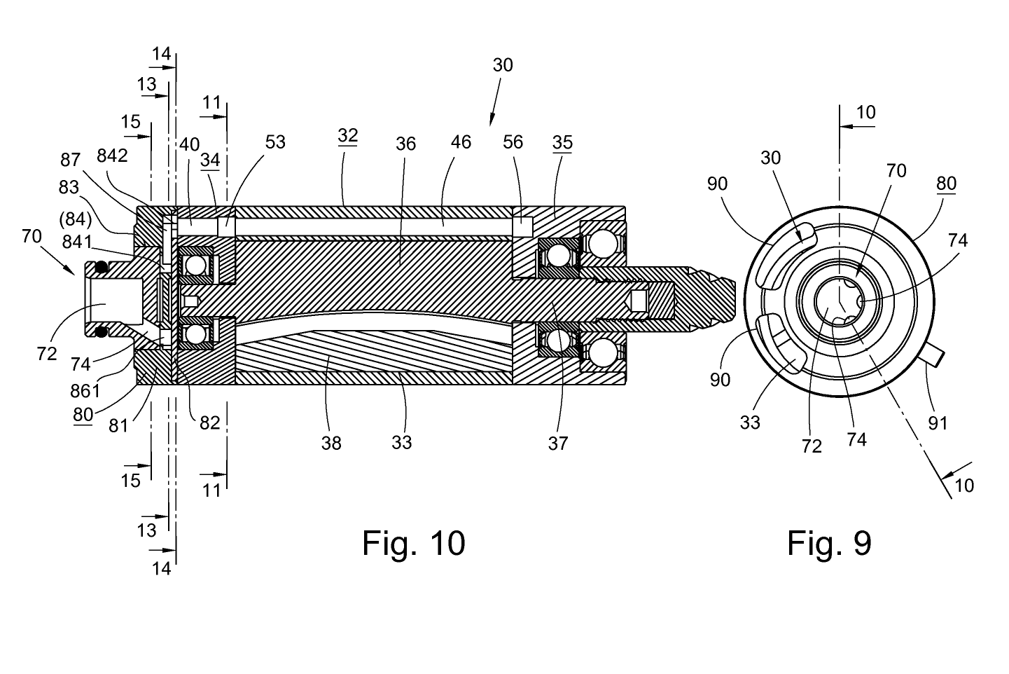

A switch 70 is arranged between the intake flow way 25 and the cylinder room 28. Referring to FIGS. 7 and 8, a rear end of the switch is formed with an air inlet 72 communicating with the intake flow way 25. A front end of the switch is formed with an air conduit 74 communicating with the air inlet 72. The switch 70 serves to switch the flowing directions of the high-pressure air. When the switch guides the high-pressure air to the intake 40 of the pneumatic cylinder 30, the high-pressure air flows into the pneumatic cylinder to drive and rotate the rotor 36 for operating the pneumatic tool 10. Reversely, when the switch guides the high-pressure air to the blowing flow way 22, the high-pressure air is blown out from the blowing nozzles 24 to remove the grinding powders and chips.

Referring to FIG. 3, in this embodiment, a blowing passage B is further formed in the pneumatic cylinder 30 as a medium communicating the air conduit 74 with the blowing flow way 22.

This embodiment will be more detailedly described hereinafter. Referring to FIGS. 7 and 8, the operation space 33 of the pneumatic cylinder 30 passes through the cylinder body 32 from one end to the other end. A guide hole 46 and a through hole 48 also pass through the cylinder body 32 from one end to the other end. The circumference of the cylinder body 32 is formed with a guide channel 49.

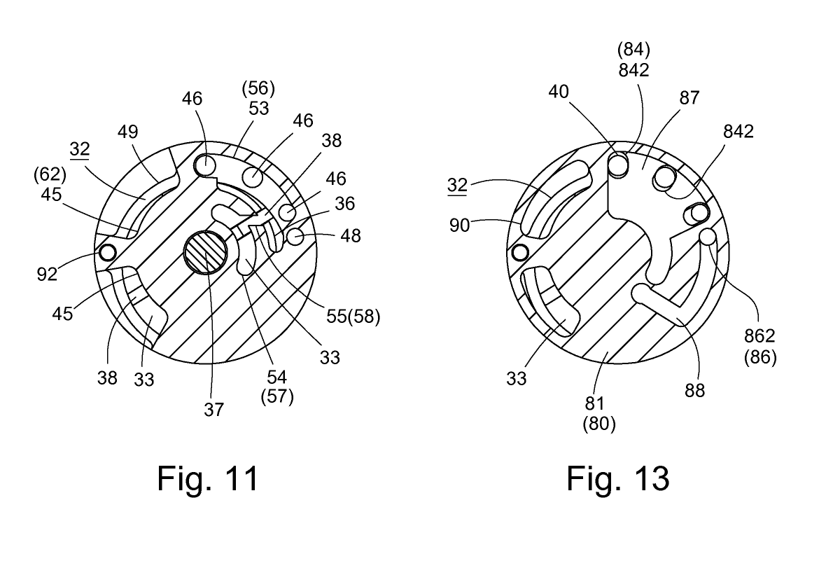

Said intake 40 is formed on the rear cylinder cap 34. A through hole 50 passes through the rear cylinder cap. The intake 40 and the through hole 50 are respectively aligned with the guide hole 46 and the through hole 48 of the cylinder body 32. Said exhaustion port 45 is also formed on the rear cylinder cap 34 to communicate with the guide channel 49 and the operation space 33 of the cylinder body 32, as shown in FIGS. 2 and 11. An inner end face of the rear cylinder cap 34 is formed with an air chamber 53 and an inner air chamber 54 closer to the center. The two air chambers 53, 54 communicate with each other via a hole 55. The air chamber 53 communicates with the intake 40. Also, as shown in FIG. 11, the air chamber 53 and the inner air chamber 54 communicate with the operation space 33 of the cylinder body 32.

An inner end face of the front cylinder cap 35 is also formed with an air chamber 56 and an inner air chamber 57 closer to the center. The two chambers 56, 57 communicate with each other via a hole 58. The air chamber 56 communicates with both the guide hole 46 and the operation space 33 of the cylinder body 32 (as shown in FIG. 11). The air chamber 57 also communicates with the operation space 33. The front cylinder cap 35 is formed with a through hole 60. An incoming end 601 of the through hole 60 is positioned on the inner end face of the front cylinder cap to communicate with the through hole 48 of the cylinder body 32 as shown in FIG. 3. Referring to FIG. 5, the outgoing end 602 of the through hole 60 is positioned on the circumference of the front cylinder cap to communicate with the rear end of the blowing flow way 22. A relief port 62 is formed on the inner end face of the front cylinder cap 35 to communicate with both the operation space 33 and the guide channel 49 of the cylinder body as shown in FIG. 2 (in the same manner as the exhaustion port 45 of FIG. 11).

The through hole 48 of the cylinder body 32 and the through holes 50, 60 of the two cylinder caps 34, 35 together form the aforesaid blowing passage B.

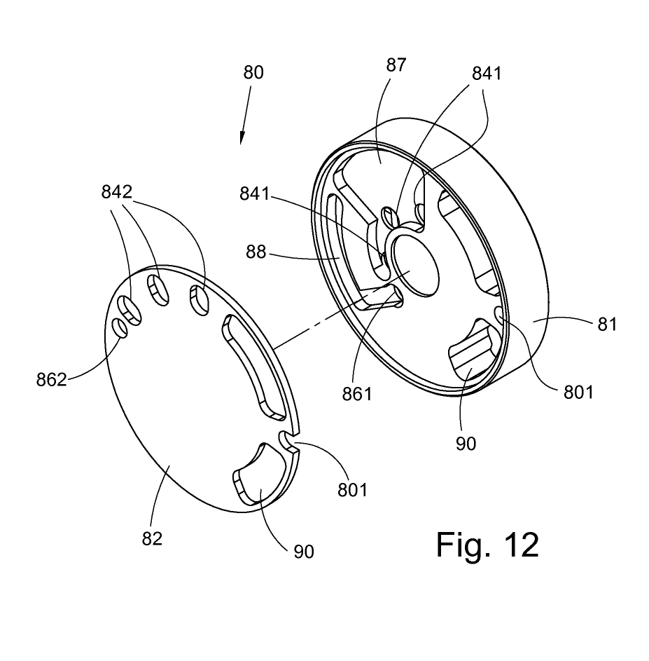

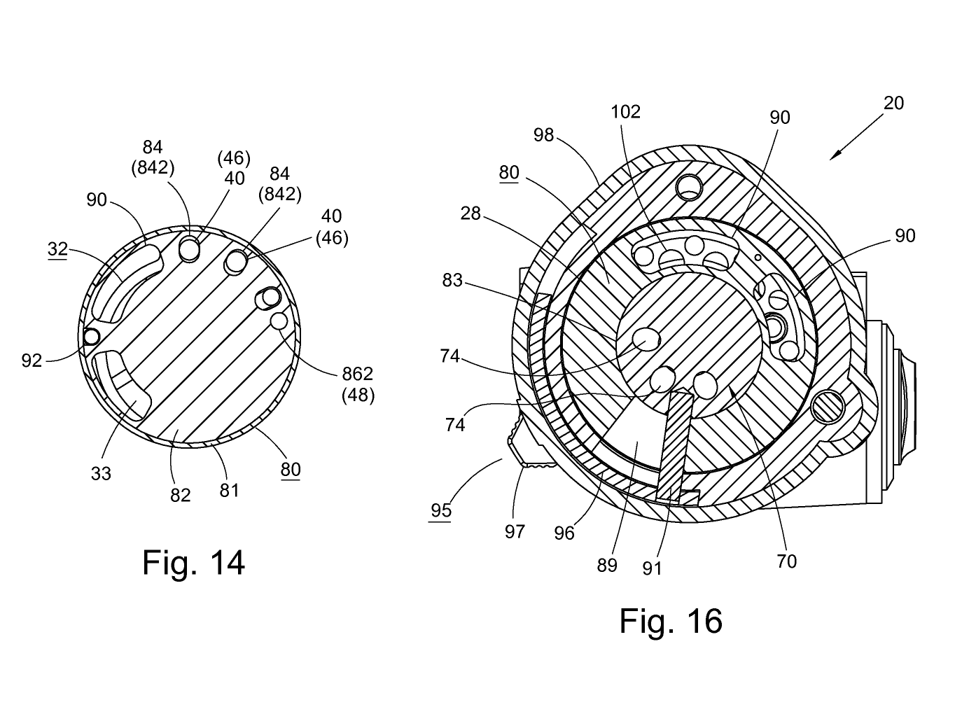

A flow-guiding seat 80 is coupled with the rear end of the pneumatic cylinder 30. A rear end face of the flow-guiding seat 80 is formed with a circular cavity 83. An intake guide opening 84 and a blowing guide opening 86 are formed in the flow-guiding seat. The incoming ends 841, 861 of the guide openings 84, 86 are positioned on the circumference of the cavity 83, while the outgoing ends 842, 862 of the guide openings 84, 86 are positioned on the front end face of the flow-guiding seat 80. Referring to FIG. 12, in this embodiment, the flow-guiding seat 80 is composed of a main body 81 and a cover board 82 covering the front end face of the main body 81. The front end face of the main body 81 is formed with two dents 87, 88. The incoming end 841 of the intake guide opening 84 communicates with the outgoing end 842 via the dent 87. The incoming end 861 of the blowing guide opening 86 communicates with the outgoing end 862 via the dent 88. It should be noted that by means of oblique drilling, the incoming and outgoing ends of the guide openings 84, 86 can be formed in the positions as shown in the figures. Accordingly, the flow-guiding seat 80 can be a one-piece part. Thus, it is unnecessary to compose the flow-guiding seat with two parts, that is, the main body and the cover board. The outgoing end 842 of the intake guide opening 84 of the flow-guiding seat 80 communicates with the intake 40 of the rear cylinder cap as shown in FIG. 14. The outgoing end 862 of the blowing guide opening 86 communicates with the through hole 48 of the rear cylinder cap. A relief port 90 is formed on the flow-guiding seat 80 in alignment with the exhaustion port 45 of the rear cylinder cap 32.

The switch 70 is rotatably disposed in the cavity 83 of the flow-guiding seat 80 as shown in FIGS. 5, 11 and 15. An insertion pin 91 is extended through a slot 89 of the flow-guiding seat and inserted in the switch 70. A locating pin 92 is inserted in the pinholes 321, 341, 351, 801 of the cylinder body 32, the two cylinder caps 34, 35 and the flow-guiding seat 80 to locate these components.

Referring to FIGS. 1 and 16, a shift button 95 is arranged on the housing 20. A button body 96 of the shift button is connected with an outer end of the insertion pin 91, while a button section 97 of the shift button is exposed to outer side of the housing for a user to shift. The housing 20 is enclosed with a soft protective jacket 98.

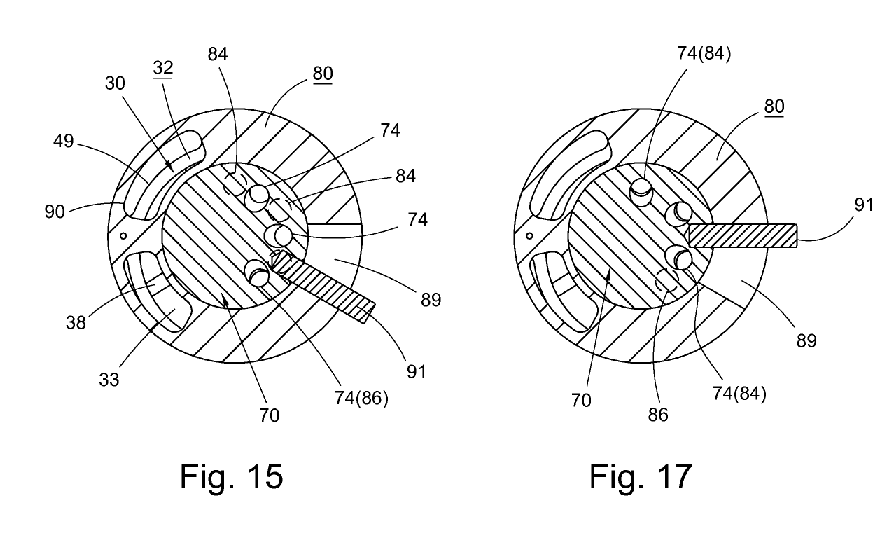

In use, the intake flow way 25 is opened, permitting high-pressure air to flow into the air inlet 72 of the switch 70. By means of the shift button 95, a user can switch the switch 70. When the switch is switched to the blowing position of FIG. 15, the air conduit 74 of the switch only communicates with the blowing guide opening 86 of the flow-guiding seat 80 without communicating with the intake guide opening 84. After the high-pressure air goes into the blowing guide opening 86 of the flow-guiding seat, the high-pressure air flows into the blowing passage B of the cylinder 30 (which is composed of the through holes 48, 50, 60) as shown in FIG. 3. Then the high-pressure air flows into the blowing flow way 22 (including the sections 221 to 224 and the annular space 225). Then the high-pressure air blows out from the blowing nozzle 24 of the housing. Accordingly, the high-pressure air can blow away the dusts. When blowing the dusts, the high-pressure air will not flow into the cylinder 30 so that the cylinder will not operate.

When grinding a work piece, the switch is switched to the intake position of FIG. 17. At this time, the air conduit 74 of the switch only communicates with the intake guide opening 84 of the flow-guiding seat 80 without communicating with the blowing guide opening 86. After the high-pressure air goes into the intake guide opening 84 of the flow-guiding seat, the high-pressure air flows into the intake 40 of the rear cylinder cap 34. At this time, there are two paths for the airflow. One is to radially flow toward the two air chambers 53, 54 of the rear cylinder cap 35 and then flow into the operation space 33 of the cylinder body 32. The other is to axially flow toward the guide hole 46 of the cylinder body to reach the two air chambers 56, 57 of the front cylinder cap 35 and then flow into the operation space 33 of the cylinder body as shown in FIG. 10. In this embodiment, the high-pressure air flows through the two cylinder caps into the cylinder body to drive and rotate the rotor 36 for operating the pneumatic tool. Then, the waste gas is exhausted out of the operation space 33 through the exhaustion port 45 of the rear cylinder cap 34 and the relief port 62 of the front cylinder cap 35. The relief port 62 and the exhaustion port 45 communicate with each other via the guide channel 49 of the cylinder body 32. Therefore, the waste gas exhausted from the two cylinder caps is together exhausted from the exhaustion port 45 of the rear cylinder cap and the relief port 90 of the flow-guiding seat 80 as shown in FIG. 2. Referring to FIGS. 3 and 16, after the waste gas is exhausted from the cylinder 30, the waste gas flows through a hole 102 of a locating member 100 (for locating the cylinder) to be exhausted from the exhaustion space 104 of rear end of the housing.

When the processing chips accumulate on the processed surface, the switch 70 is switched to the blowing position of FIG. 15 to blow away the dusts and chips.

It should be noted that in practice, the high-pressure air can be only guided in from the rear cylinder cap and the waste gas is only exhausted from the rear cylinder cap. Under such circumstance, it is unnecessary to form the air chambers and the relief port on the front cylinder cap, and the circumference of the cylinder body is free from the guide channel.

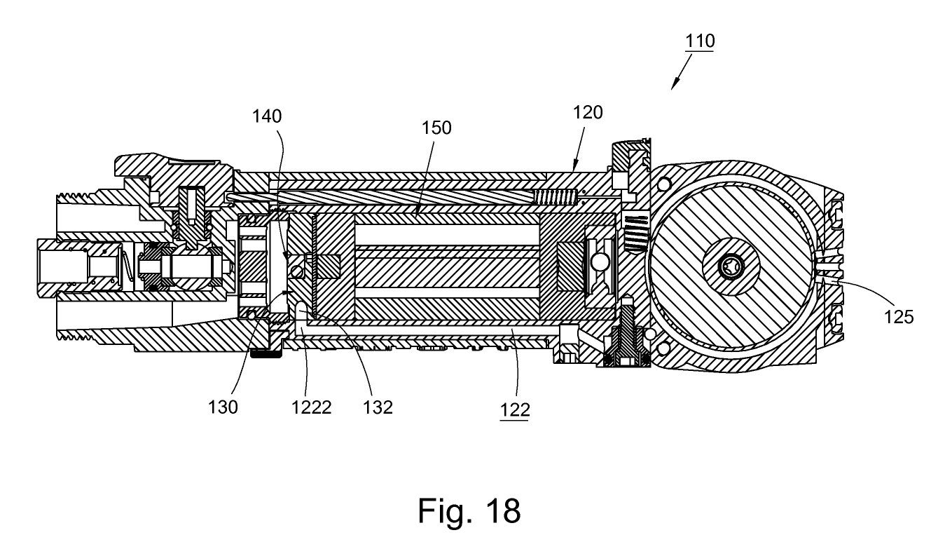

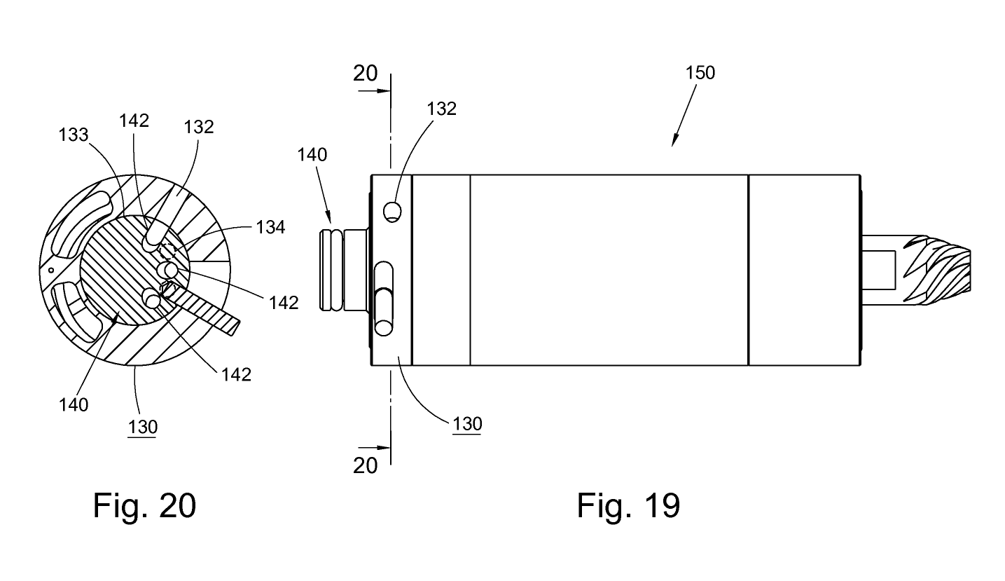

FIGS. 18 to 20 show another embodiment of the pneumatic tool 110 of the present invention, in which the rear end 1222 of the blowing flow way 122 is aligned with the flow-guiding seat 130 as shown in FIG. 18. Referring to FIG. 20, the incoming end of the blowing guide opening 132 of the flow-guiding seat 130 communicates with the cavity 133. The outgoing end of the blowing guide opening 132 is positioned on the circumference of the flow-guiding seat to communicate with the rear end 1222 of the blowing flow way 122 as shown in FIG. 18. When the switch 140 is positioned in the blowing position of FIG. 20, the air conduit 142 communicates with the blowing guide opening 132 of the flow-guiding seat 130 without communicating with the intake guide opening 134. Accordingly, the high-pressure air can go through the air conduit 142 and the blowing guide opening 132 to flow into the blowing flow way 122 and blow out from the blowing nozzle 125 of the housing 120. When the switch 140 is switched to the intake position (not shown), the air conduit 142 communicates with the intake guide opening 134 of the flow-guiding seat 130, whereby the high-pressure air can drive the cylinder 150.

In this embodiment, it is unnecessary to form the blowing passage in the cylinder 150 as in the above embodiment.

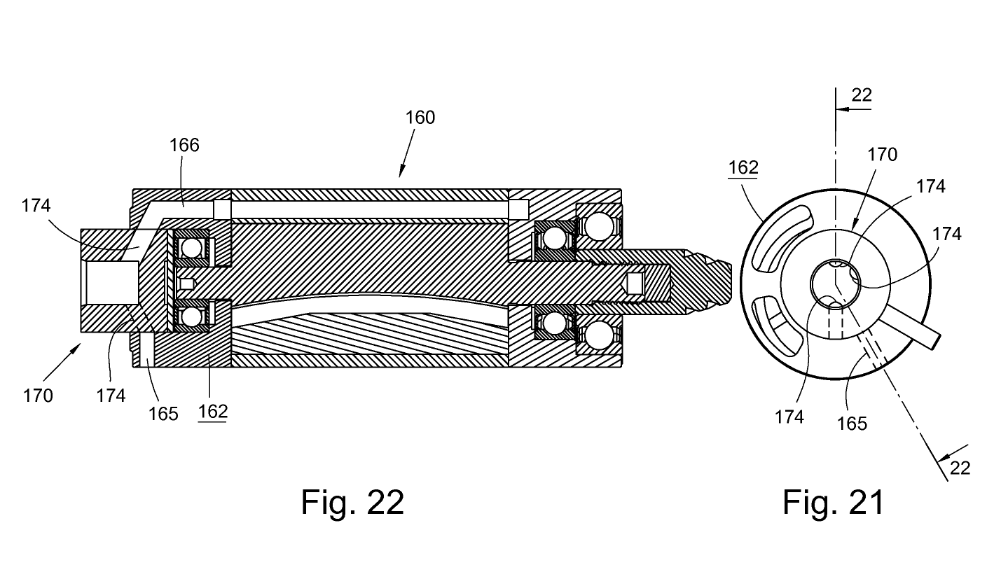

FIGS. 21 and 22 show still another embodiment of the present invention, in which only the cylinder 160 and the switch 170 are shown. The blowing flow way (not shown) of this embodiment is identical to that of FIG. 18.

The rear end face of the rear cylinder cap 162 of the cylinder 160 is formed with a cavity 164. A blowing guide opening 165 is formed on the rear cylinder cap. An incoming end of the blowing guide opening is positioned in the cavity 164, while an outgoing end of the blowing guide opening is positioned on the circumference of the rear cylinder cap to communicate with the rear end of the blowing flow way. The switch 170 is rotatably disposed in the cavity 164. FIGS. 21 and 22 show that the switch 170 is positioned in the intake position. At this time, the air conduit 174 of the switch communicates with the intake 166 of the cylinder 160 without communicating with the blowing guide opening 165. Therefore, the high-pressure air can be guided into the cylinder. Reversely, when the switch is switched to the blowing position (not shown), the air conduit 174 communicates with the blowing guide opening 165. At this time, the high-pressure air is guided into the blowing flow way to blow out from the blowing nozzle of the housing. In this embodiment, there is no flow-guiding seat.

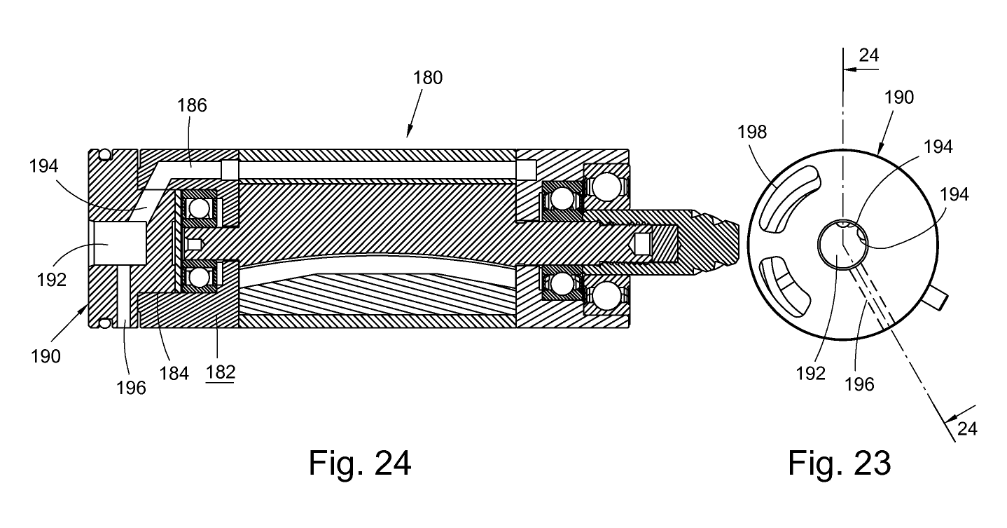

FIGS. 23 and 24 show the cylinder 180 and the switch 190 of still another embodiment of the present invention. The blowing flow way of this embodiment is identical to that of FIG. 18.

The front end of the switch 190 is rotatably disposed in the cavity 184 of the rear end face of the rear cylinder cap 182. Both an intake guide opening 194 and a blowing guide opening 196 are formed in the switch 190 to communicate with the air inlet 192. The blowing guide opening 196 communicates with the air inlet 172 and the outer circumference of the switch. When the switch 190 is positioned in the intake position of FIG. 24, the intake guide opening 194 communicates with the intake 186 of the cylinder 180 for guiding the high-pressure air into the cylinder. At this time, the blowing guide opening 196 does not communicate with the blowing flow way. Reversely, when the switch is switched to the blowing position (not shown), the blowing guide opening 196 communicates with the blowing flow way, whereby the high-pressure air can be guided to blow out from the blowing nozzle of the housing. In addition, the switch 190 is formed with a relief port 198 to communicate with the exhaustion port of the cylinder.

According to the above arrangement, a user can switch the switch to operate the pneumatic tool or blow away the dusts. The high-pressure air serves as the blowing source so that the processing chips can be strongly blown away to clean up the processed surface. Therefore, an operator can more clearly realize the processing progress.

The above embodiments are only used to illustrate the present invention, not intended to limit the scope thereof. Many modifications of the above embodiments can be made without departing from the spirit of the present invention.

What is claimed is:

1. A pneumatic tool with dust-blowing effect, comprising:
a housing formed with an internal blowing flow way and an intake flow way; a blowing nozzle being disposed on a certain section of the housing and connected with a front end of the blowing flow way; a cylinder room being formed in the housing, whereby a rear end of the cylinder room can communicate with a front end of the intake flow way;
a pneumatic cylinder having a cylinder body and a front and a rear cylinder caps respectively covering two ends of the cylinder body; an operation space being formed in the cylinder body for installing a rotor; an intake and an exhaustion port being formed on the cylinder to communicate with the operation space; the pneumatic cylinder being installed in the cylinder room;
a switch arranged between the intake flow way and the cylinder room and switchable between an intake position and a blowing position; a rear end of the switch providing an air inlet communicating with the intake flow way; a front end of the switch providing an air conduit communicating with the air inlet; and
a shift button mounted on the housing and connected with the switch for a user to shift and switch the switch; whereby when the switch is switched to the intake position, the air conduit of the switch communicates with the intake of the cylinder, while when the switch is switched to the blowing position, the air conduit communicates with the rear end of the blowing flow way.

2. The pneumatic tool as claimed in claim 1, wherein a blowing passage is formed in the cylinder, an outgoing end of the blowing passage communicating with the rear end of the blowing flow way; whereby when switching the switch to the blowing position, the air conduit communicates with the incoming end of the blowing passage.

3. The pneumatic tool as claimed in claim 1, wherein the intake of the cylinder is formed on the rear cylinder cap; the pneumatic tool further comprising a flow-guiding seat formed with an intake guide opening, the flow-guiding seat being coupled with the rear cylinder cap, an outgoing end of the intake guide opening communicating with the intake; the switch being rotatably connected with a rear end face of the flow-guiding seat, whereby when the switch is positioned in the intake position, the air conduit communicates with the incoming end of the intake guide opening.

4. The pneumatic tool as claimed in claim 3, wherein a rear end face of the flow-guiding seat is formed with a cavity; the incoming end of the intake guide opening is positioned on a circumference of the cavity; the switch being rotatably disposed in the cavity.

5. The pneumatic tool as claimed in claim 2, wherein the intake of the cylinder is formed on the rear cylinder cap; the incoming end of the blowing passage being positioned on the rear cylinder cap; the pneumatic tool further comprising a flow-guiding seat formed with an intake guide opening and a blowing guide opening, the flow-guiding seat being coupled with the rear cylinder cap, an outgoing end of the intake guide opening communicating with the intake; an incoming end of the blowing passage communicating with the blowing guide opening; the switch being rotatably connected with a rear end face of the flow-guiding seat, whereby when the switch is positioned in the blowing position, the air conduit communicates with the incoming end of the blowing passage, while when the switch is positioned in the intake position, the air conduit communicates with the incoming end of the intake guide opening.

6. The pneumatic tool as claimed in claim 5, wherein a rear end face of the flow-guiding seat is formed with a cavity; the incoming end of the intake guide opening and the incoming end of the blowing guide opening are both positioned on a circumference of the cavity; the switch being rotatably disposed in the cavity.

7. The pneumatic tool as claimed in claim 4, further comprising a pin, an inner end of the pin being connected with the switch; the shift button being connected with an outer end of the pin.

8. The pneumatic tool as claimed in claim 7, wherein the flow-guiding seat is formed with a radial tunnel communicating with the cavity; the pin being fitted through the tunnel.

9. The pneumatic tool as claimed in claim 2, wherein each of the cylinder body and the two cylinder caps is formed with a through hole, the through holes communicating with each other to form said blowing passage; the rear end of the blowing flow way communicating with the through hole of the front cylinder cap.

10. The pneumatic tool as claimed in claim 1, wherein the cylinder body is axially formed with a guide hole passing through the cylinder body; the intake communicating with the guide hole, the inner end face of the rear cylinder cap being formed with an air chamber communicating with the intake and the operation space of the cylinder body; an inner end face of the front cylinder cap being also formed with an air chamber communicating with both the guide hole and the operation space of the cylinder body.

11. The pneumatic tool as claimed in claim 10, wherein the cylinder body is axially formed with a guide channel; the exhaustion port communicating with the guide channel and the operation space; an inner circumference of the front cylinder cap being formed with a relief port communicating with the operation space and the guide channel of the cylinder body.

12. The pneumatic tool as claimed in claim 3, wherein the flow-guiding seat is formed with a relief port corresponding to the exhaustion port.

13. The pneumatic tool as claimed in claim 4, wherein the flow-guiding seat includes a main body and a cover board covering a front end face of the main body; the outgoing end of the intake guide opening being formed on the cover board; a dent being formed on the front end face of the main body, whereby the outgoing end and incoming end of the intake guide opening communicate with each other via the dent.

14. The pneumatic tool as claimed in claim 6, wherein the flow-guiding seat includes a main body and a cover board covering a front end face of the main body; the outgoing ends of the blowing guide opening and the intake guide opening being formed on the cover board; a first dent and a second dent being formed on the front end face of the main body, whereby the outgoing end and incoming end of the intake guide opening communicate with each other via the first dent, and the outgoing end and incoming end of the blowing guide opening communicate with each other via the second dent.

15. The pneumatic tool as claimed in claim 1, wherein the intake of the cylinder is formed on the rear cylinder cap; the pneumatic tool further comprising a flow-guiding seat formed with an intake guide opening and a blowing guide opening, the flow-guiding seat being disposed at a rear end of the rear cylinder cap, an outgoing end of the intake guide opening communicating with the intake; an outgoing end of the blowing guide opening being positioned on a circumference of the flow-guiding seat to communicate with a rear end of the blowing flow way; the switch being disposed at a rear end of the flow-guiding seat, whereby when the switch is positioned in the blowing position, the air conduit communicates with the incoming end of the blowing guide opening, while when the switch is positioned in the intake position, the air conduit communicating with the incoming end of the intake guide opening.

16. The pneumatic tool as claimed in claim 15, wherein the rear end face of the pneumatic cylinder is formed with a cavity; the incoming ends of the intake guide opening and the blowing guide opening are both positioned on a circumference of the cavity; a front end of the switch being rotatably disposed in the cavity.

17. A pneumatic tool with dust-blowing effect, comprising:
a housing formed with an internal blowing flow way and an intake flow way; a blowing nozzle being disposed on a certain section of the housing and connected with a front end of the blowing flow way; a cylinder room being formed in the housing;
a pneumatic cylinder being installed in the cylinder room and having a cylinder body and a front and a rear cylinder caps respectively covering two ends of the cylinder body; an operation space being formed in the cylinder body; an intake being formed on the rear cylinder cap to communicate with the operation space; an exhaustion port being formed on the cylinder to communicate with the operation space; a blowing guide opening being formed on the rear cylinder cap, an outgoing end of the blowing guide opening communicating with a rear end of the blowing flow way;
a switch disposed at the rear end of the rear cylinder cap and switchable between an intake position and a blowing position; a rear end of the switch providing an air inlet, a front end of the switch being formed with an air conduit communicating with the air inlet; and
a shift button mounted on the housing and connected with the switch for a user to shift and switch the switch, whereby when the switch is switched to the intake position, the air conduit of the switch communicates with the intake, while when the switch is switched to the blowing position, the air conduit communicates with the incoming end of the blowing guide opening.

18. The pneumatic tool as claimed in claim 17, wherein the rear end face of the rear cylinder cap is formed with a cavity; a front end of the switch being rotatably disposed in the cavity; the incoming end of the intake and the incoming end of the blowing guide opening being both positioned on a circumference of the cavity.

19. A pneumatic tool with dust-blowing effect, comprising:
a housing formed with an internal blowing flow way and an intake flow way; a blowing nozzle being disposed on a certain section of the housing and connected with a front end of the blowing flow way; a cylinder room being formed in the housing;
a pneumatic cylinder formed with an internal operation space; an intake and an exhaustion port being formed on a rear end of the cylinder to communicate with the operation space; the pneumatic cylinder being installed in the cylinder room;
a switch disposed at the rear end of the cylinder and switchable between an intake position and a blowing position, a rear end of the switch having an air inlet; an intake guide opening and a blowing guide opening being formed in the switch, an incoming end of the intake guide opening and an incoming end of the blowing guide opening both communicating with the air inlet; an outgoing end of the blowing guide opening being positioned on a circumference of the switch in aligned with the rear end of the blowing flow way; and
a shift button mounted on the housing and connected with the switch, whereby when the switch is switched to the intake position, the outgoing end of the intake guide opening of the switch communicates with the intake of the cylinder, while when the switch is switched to the blowing position, the outgoing end of the blowing guide opening communicates with the rear end of the blowing flow way.

20. The pneumatic tool as claimed in claim 19, wherein the switch is formed with a relief port to communicate with the exhaustion port of the pneumatic cylinder.
